(19) United States
(12) Patent Application Publication
(10) Pub. No.: US 2005/0120374 A1
(43) Pub. Date: Jun. 2, 2005

(54) Methods and apparatus for passing an on-screen display over a serial interface

(75) Inventors: Christopher J. Stone, Newtown, PA (US); Stephen A. Allinson, Langhorne, PA (US); Brad T. Howard, Lawrenceville, GA (US); Terry L. Ziegler, Lansdale, PA (US); Chris Del Sordo, Souderton, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/725,144

(22) Filed: Dec. 1, 2003

(51) Int. Cl. H04N 7/173; H04N 7/18; H04N 7/16

(52) U.S. Cl. 725/80; 725/131; 725/151; 725/100; 725/74

(57) ABSTRACT

The present invention provides methods and apparatus for passing an on-screen display (OSD) from a source device, such as a television terminal, to a sink device, such as a high definition television (HDTV), over a serial interface, such as an IEEE-1394 interface. The source device includes a tuner adapted for receiving an active isochronous MPEG data stream and graphic data for an OSD. A serial interface at the source device enables communication with a sink device. A processor at the source device detects an action requiring an OSD at the sink device. The source device also includes an MPEG encoder adapted for encoding the graphic data as an isochronous MPEG data stream carrying the OSD. The isochronous MPEG data stream carrying the OSD may then be passed to the sink device via the serial interface.

### BACKGROUND OF THE INVENTION

The present invention relates generally to video signals. More specifically, the present invention relates to methods and apparatus for passing an on-screen display (OSD) from a source device, such as a television terminal, to a sink device, such as a high definition television (HDTV), over a serial interface, such as an IEEE-1394 interface.

Prior art IEEE-1394 networks require that an on-screen display be transmitted from a source device to a sink device as bit map data using asynchronous methods, such as those defined in Electronic Industries Association standards EIA-775 and EIA-799. These methods are very CPU intensive and are not widely supported. Therefore, there is no reliable prior art mechanism for passing an on-screen display (e.g., an electronic programming guide (EPG), video on demand capabilities, diagnostic capabilities) from a source device (e.g., a cable/satellite/off-air television receiver terminal) to a sink device (e.g., a high definition television (HDTV)) over an IEEE-1394 connection.

The present invention overcomes the disadvantages of the prior art by enabling the on-screen display to be passed over an IEEE-1394 interface as an isochronous MPEG data stream.

The methods and apparatus of the present invention provide the foregoing and other advantages.

### SUMMARY OF THE INVENTION

The present invention provides methods and apparatus for passing an on-screen display from a source device, such as a cable/satellite/off-air television receiver terminal, to a sink device, such as a high definition television (HDTV), over a serial interface, such as an IEEE-1394 interface.

In an example embodiment of the invention, a source device capable of passing an on-screen display over a serial interface is provided. The source device includes a tuner adapted for receiving an active isochronous MPEG data stream and graphic data for an OSD. A serial interface at the source device enables communication with a sink device. A processor at the source device is adapted for detecting an action requiring an on-screen display at the sink device. The source device also includes an MPEG encoder adapted for encoding the graphic data as an isochronous MPEG data stream carrying the OSD (also referred to herein as “OSD data stream”). The isochronous MPEG data stream carrying the OSD may then be passed to the sink device via the serial interface.

Corresponding methods and apparatus are provided in accordance with the present invention.

### BRIEF DESCRIPTION OF THE DRAWINGS

The present invention will hereinafter be described in conjunction with the appended drawing figures, wherein like reference numerals denote like elements, and:

FIG. 1 shows a block diagram of a source device in accordance with an example embodiment of the invention;

FIG. 2 shows a block diagram of a first example embodiment of the invention;

FIG. 3 shows an example on-screen display in accordance with an example embodiment of the present invention;

FIG. 4 shows a block diagram of a second example embodiment of the invention; and

FIG. 5 shows a block diagram of a third example embodiment of the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

Although the invention is described in connection with an IEEE-1394 interface, those skilled in the art will appreciate that the present invention is compatible with any type of serial interface now known in the art or that will be developed in the future.

The present invention provides methods and apparatus by which the source device passes the on-screen display (OSD) through an MPEG encoder to produce an isochronous MPEG data stream, which can be passed over an IEEE-1394 connection to the sink device. The source device includes means to determine when a user has activated the OSD (e.g., an EPG) and to “switch” the current active isochronous stream, which provides a video service (e.g., a tuned television channel, digitally recorded content, and the like) to the isochronous stream containing the OSD. The source device also contains means to determine when the user has deactivated the OSD and switched back to the isochronous stream providing the video service.

With the present invention, any sink device that is capable of processing an isochronous MPEG data stream has the capability to provide the user with an OSD over an IEEE-1394 interface.

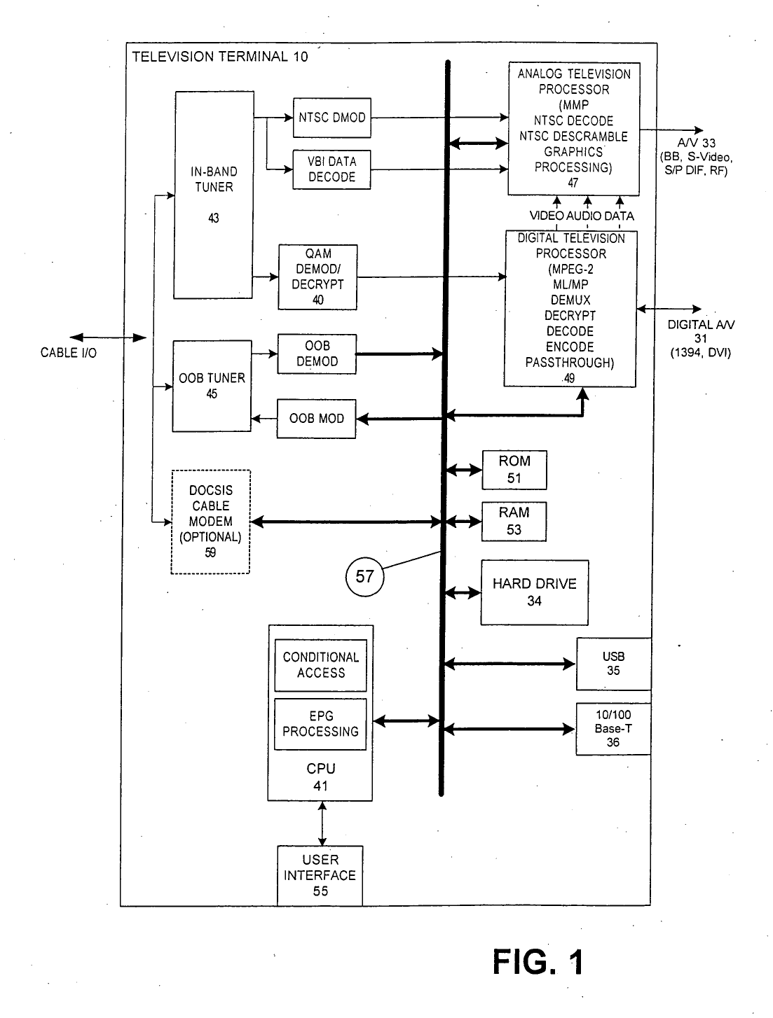

FIG. 1 shows an example embodiment of a source device (e.g., cable television receiver terminal 10) capable of passing an on-screen display over a serial interface in accordance with the present invention. The source device 10 includes a tuner (e.g., in-band tuner 43 and/or out-of-band tuner 45) adapted for receiving an active isochronous MPEG data stream and graphic data for an OSD. A processor (e.g., CPU 41) at the source device 10 is adapted for detecting an action requiring an on-screen display at the sink device (e.g., via user interface 55). A digital television processor 49 at the source device is responsible for various digital television processing functions, including, demultiplexing, decoding, MPEG encoding, multiplexing encrypting, and decrypting of digital television signals, as is known in the art. The remaining components of the source device 10 are standard components that are well known in the art, and are not pertinent to the invention.

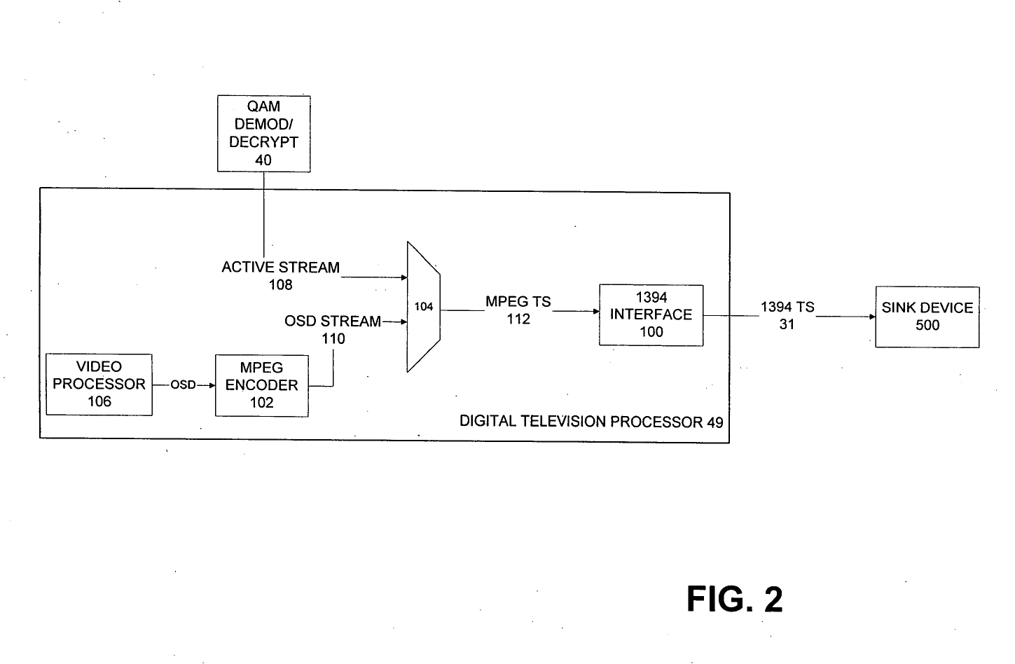

FIG. 2 shows an example implementation of the digital television processor 49 in accordance with the present invention. A serial interface (e.g., IEEE-1394 interface 100) enables the source device 10 to communicate with a sink device 500. The digital television processor 49 of the source device 10 also includes an MPEG encoder 102 adapted for encoding the graphic OSD data as an isochronous MPEG data stream 110 carrying the OSD (also referred to herein as “OSD data stream”). The isochronous MPEG data stream 110 carrying the OSD may then be passed to the sink device 500 via the serial interface 100 (e.g., as 1394 transport stream 31).

The isochronous MPEG data stream carrying the OSD 31 may be received at the sink device 500 from serial interface 100. Once received, the isochronous MPEG data stream carrying the OSD 31 may then be decoded at the sink device 500 to provide the on-screen display as if it were a regular MPEG video stream. This enables a near real-time OSD, where cursor moves, screen highlights and the like are visible to the user as if the OSD were being displayed via analog outputs.

The serial interface 100 may comprise an IEEE-1394 interface, or any other type of serial interface.

In the example embodiment of the invention shown in FIG. 2, the OSD data is processed through a video processor 106 and on to the MPEG encoder 102 to produce the isochronous MPEG data stream 110 with an associated program identifier (PID). The PID for the OSD data stream 110 may be assigned by the MPEG encoder 102. A multiplexer 104 may multiplex the isochronous MPEG data stream carrying the OSD 110 and the associated PID with an active isochronous MPEG data stream 108 to provide a multiplexed transport stream 112. The processor 41 may modify a program map table (PMT) of the multiplexed transport stream 112 to point to the PID of the OSD data stream rather than a PID of a video component of the active isochronous MPEG data stream 108. The isochronous data stream carrying the OSD 110 may then be passed to the sink device 500 in the multiplexed transport stream 112. In this example embodiment, the sink device 500 receives two data streams, one stream containing the audio and video components of the active data stream 108, and the OSD data stream 110. However, the sink device 500 decodes the isochronous MPEG data stream containing the on-screen display 110 rather than the video component of the active data stream 108, due to the modification of the program map table.

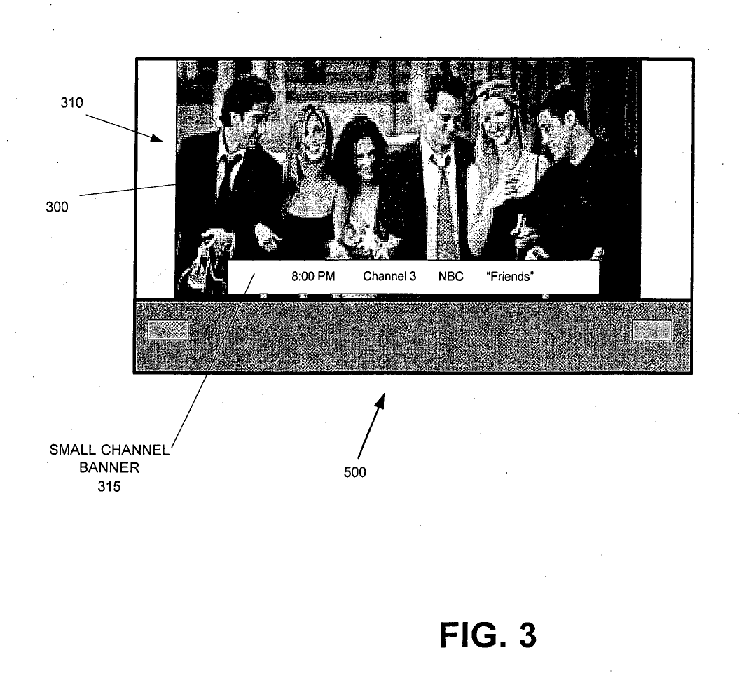

Alternatively, the program map table of the multiplexed transport stream 112 may be modified to identify the isochronous data stream carrying the on-screen display 110 as a secondary video source, wherein a video component of the active isochronous MPEG data stream 108 comprises a primary video source. For example, the program map table may be modified to contain a descriptor or unique stream identifier which identifies the OSD data stream 110. In this example embodiment, the sink device 500 may alpha blend the primary and secondary video sources (i.e., the video component of the active data stream 108 and the OSD data stream 110). In addition, providing the OSD data stream as a secondary video source enables the sink device 500 to display the OSD over a portion of the active video. For example, as shown in FIG. 3, the active video 300 may be displayed in the background, instead of a black background, and the OSD may comprise a small region of the display 310, such as a small channel banner 315.

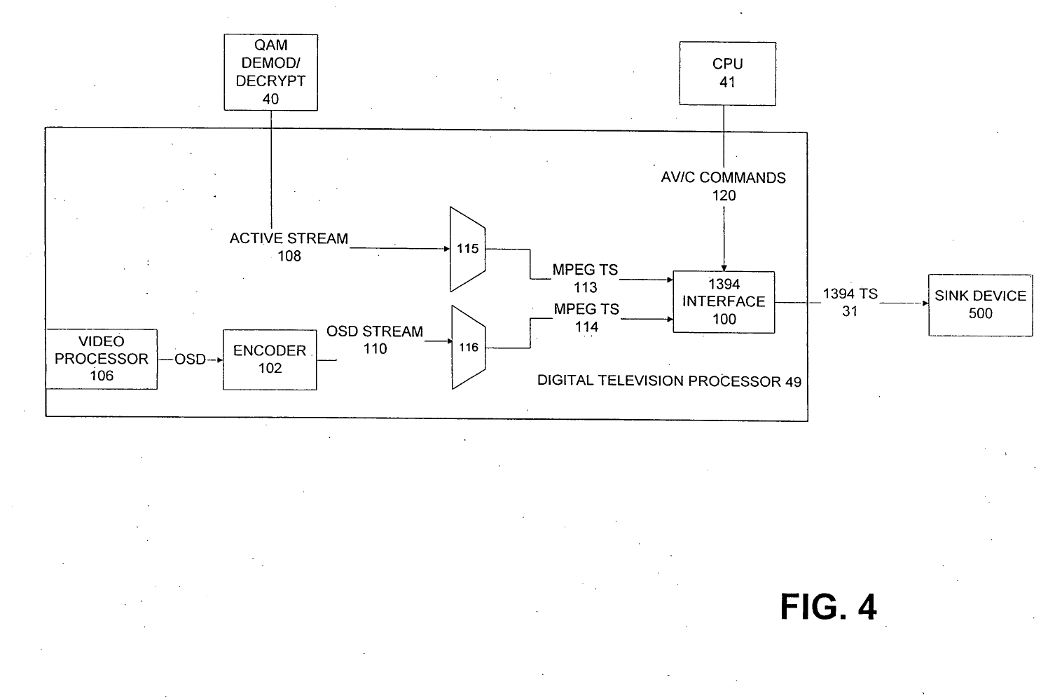

A further example embodiment of the invention is shown in FIG. 4. In the example embodiment shown in FIG. 4, the isochronous MPEG data stream 110 carrying the on-screen display and the active isochronous MPEG data stream 108 may be provided to the serial interface 100 as separate transport streams 113 and 114. Transport stream 114 contains the OSD data stream 110 and is the result of multiplexing at multiplexer 116. Transport stream 113 contains the active data stream 108 and is the result of multiplexing at multiplexer 115. Audio/video control (AV/C) commands 120 from the CPU 41 may be provided to the serial interface 100 to enable a selection between the active isochronous MPEG data stream (transport stream 113) and the isochronous MPEG data stream carrying the on-screen display (transport stream 114). In this example embodiment, the AV/C commands 120 are used to select whether transport stream 114 carrying the OSD data stream 110 or transport stream 113 carrying the active data stream 108 will be passed to the sink device 500 in the 1394 transport stream 31.

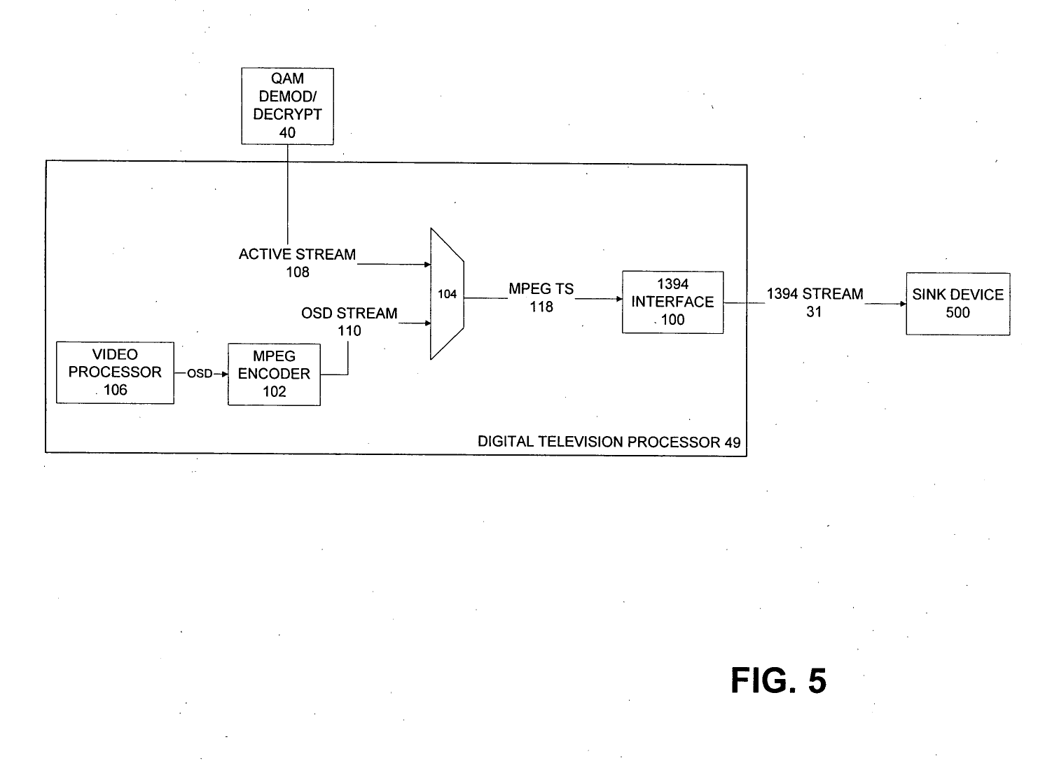

Another example embodiment of the invention is shown in FIG. 5. In the FIG. 5 example embodiment, the isochronous MPEG data stream 110 carrying the OSD may be multiplexed at multiplexer 104 with an active isochronous MPEG data stream 108 to produce a multiplexed transport stream 118. As is known to those skilled in the art, the active isochronous MPEG data stream contains a video component and an audio component. During multiplexing, the isochronous MPEG data stream 110 carrying the OSD may be substituted in place of an active video component of the active isochronous MPEG data stream 108. The isochronous MPEG data stream 110 carrying the OSD may then be passed to the sink device 500 in the transport stream 118 (e.g., as 1394 stream 31). A program identifier (PID) of the active video component may be maintained as a PID of the isochronous MPEG data stream 110 carrying the OSD. In this example embodiment, the OSD data stream 110 is substituted in place of the video component of the active data stream 108 so that the sink device 500 will decode the OSD data stream 110, thinking it is the active video component of the active data stream 108.

The source device 10 may comprise a television terminal or similar device. The sink device 500 may comprise a high definition television.

In general, the OSD may comprise almost any type of non-video graphic that is displayed on a screen of a high definition television on top of and/or in place of the video. For example, the on-screen display may comprise an electronic programming guide (EPG), a diagnostic menu, a video on demand menu, an advertisement, a pop-up graphic, an alert, a notice (e.g., an email notification or incoming telephone call notification), a web page, a stock ticker, a sports ticker, information menus, barkers associated with the electronic program guide, or the like.

The action requiring the OSD may comprise a user driven action or a software driven action. A user driven action may be a remote control input received via user interface 55, for example a request for an EPG or the like. A software driven action may be an alert, a notification, or an unsolicited pop-up advertisement. An alert may advise a viewer of a connection problem, a hardware failure, or the like. A notification may advise a viewer of an incoming email, an incoming telephone call, or the like.

The processor 41 may also detect an action at the sink device 500 deactivating the on-screen display. In response, the source device 10 may disable the passing of the isochronous MPEG data stream carrying the OSD to the sink device 500 and provide in its place the active isochronous MPEG data stream 108. For example, once a user turns off the EPG, the source device will resume sending active video containing television programming in place of the OSD data stream 110.

It should now be appreciated that the present invention provides advantageous methods and apparatus for passing an on-screen display from a source device, such as a television terminal, to a sink device, such as a high definition television (HDTV), over a serial interface, such as an IEEE-1394 interface.

Although the invention has been described in connection with various illustrated embodiments, numerous modifications and adaptations may be made thereto without departing from the spirit and scope of the invention as set forth in the claims.

1. A method for passing an on-screen display over a serial interface, comprising:
detecting at a source device an action requiring an on-screen display at a sink device;
encoding the on-screen display at the source device as an isochronous MPEG data stream; and
passing said isochronous MPEG data stream carrying said on-screen display to said sink device via said serial interface.

2. A method in accordance with claim 1, wherein:
said serial interface comprises an IEEE-1394 interface.

3. A method in accordance with claim 1, further comprising:
providing said isochronous MPEG data stream carrying said on-screen display with an associated program identifier (PID);
multiplexing the isochronous MPEG data stream carrying said on-screen display and said associated PID with an active isochronous MPEG data stream to provide a multiplexed transport stream; and
wherein said isochronous data stream carrying said on-screen display is passed to said sink device in said multiplexed transport stream.

4. A method in accordance with claim 3, further comprising:
modifying a program map table of the multiplexed transport stream to point to the PID of the isochronous data stream carrying said on-screen display rather than a PID of a video component of said active isochronous MPEG data stream.

5. A method in accordance with claim 3, further comprising:
modifying a program map table of the multiplexed transport stream to identify the isochronous data stream carrying the on-screen display as a secondary video source, wherein a video component of said active isochronous MPEG data stream comprises a primary video source.

6. A method in accordance with claim 1, wherein:
the isochronous MPEG data stream carrying said on-screen display and an active isochronous MPEG data stream are provided to said serial interface as separate transport streams to be passed to said sink device; and
audio/video control commands are provided to said serial interface to enable a selection between said active isochronous MPEG data stream and said isochronous MPEG data stream carrying said on-screen display.

7. A method in accordance with claim 1, further comprising:
multiplexing said isochronous MPEG data stream carrying said on-screen display with an active isochronous MPEG data stream to produce a multiplexed transport stream wherein said isochronous MPEG data stream carrying said on-screen display is substituted in place of an active video component of said active isochronous MPEG data stream;
wherein said isochronous MPEG data stream carrying said on-screen display is passed to said sink device in said transport stream.

8. A method in accordance with claim 7, further comprising:
maintaining a program identifier (PID) of said active video component as a PID of the isochronous MPEG data stream carrying said on-screen display.

9. A method in accordance with claim 1, further comprising;
receiving said isochronous MPEG data stream carrying said on-screen display at said sink device; and
decoding said isochronous MPEG data stream carrying said on-screen display to provide said on-screen display.

10. A method in accordance with claim 1, wherein:
said source device comprises a television terminal; and
said sink device comprises a high definition television.

11. A method in accordance with claim 1, wherein:
said on-screen display comprises one of an electronic programming guide, a diagnostic menu, a video-on-demand menu, an advertisement, a pop-up graphic, an alert, a notice, a web page, a stock ticker, or a sports ticker.

12. A method in accordance with claim 1, wherein:
said action comprises one of a user driven action or a software driven action.

13. A method in accordance with claim 1, further comprising:
detecting at said source device an action deactivating the on-screen display;
disabling said passing of said isochronous MPEG data stream carrying said on-screen display to said sink device; and
providing said active isochronous MPEG data stream to said sink device.

14. A source device capable of passing an on-screen display over a serial interface, comprising:
a tuner adapted for receiving an active isochronous MPEG data stream and graphic data for an on-screen display;
a serial interface adapted for communication with a sink device;
a processor adapted for detecting an action requiring an on-screen display at said sink device; and
an MPEG encoder adapted for encoding said graphic data as an isochronous MPEG data stream carrying said on-screen display to enable said isochronous MPEG data stream carrying said on-screen display to be passed to said sink device via said serial interface.

15. A source device in accordance with claim 14, wherein:
said serial interface comprises an IEEE-1394 interface.

16. A source device in accordance with claim 14, further comprising:
a multiplexer; wherein:
said encoder provides said isochronous MPEG data stream carrying said on-screen display with an associated program identifier (PID);
said multiplexer multiplexes the isochronous MPEG data stream carrying said on-screen display and said associated PID with an active isochronous MPEG data stream to provide a multiplexed transport stream; and
said isochronous data stream carrying said on-screen display is passed to said sink device in said multiplexed transport stream.

17. A source device in accordance with claim 16, wherein:
said processor modifies a program map table of the multiplexed transport stream to point to the PID of the isochronous data stream carrying the on-screen display rather than a PID of a video component of said active isochronous MPEG data stream.

18. A source device in accordance with claim 16, wherein:
said processor modifies a program map table of the multiplexed transport stream to identify the isochronous data stream carrying the on-screen display as a secondary video source, wherein a video component of said active isochronous MPEG data stream comprises a primary video source.

19. A source device in accordance with claim 14, wherein:
the isochronous MPEG data stream carrying said on-screen display and an active isochronous MPEG data stream are provided to said serial interface as separate transport streams;
audio/video control commands are provided to said serial interface to enable a selection between said active isochronous MPEG data stream and said isochronous MPEG data stream carrying said on-screen display.

20. A source device in accordance with claim 14, further comprising:
a multiplexer; wherein:
said isochronous MPEG data stream carrying said on-screen display is multiplexed with an active isochronous MPEG data stream to produce a multiplexed transport stream wherein said isochronous MPEG data stream carrying said on-screen display is substituted in place of an active video component of said active isochronous MPEG data stream;
wherein said isochronous MPEG data stream carrying said on-screen display is passed to said sink device in said transport stream.

21. A source device in accordance with claim 20, wherein:
a program identifier (PID) of said active video component is maintained as a PID of the isochronous MPEG data stream carrying said on-screen display.

22. A source device in accordance with claim 14, wherein;
said isochronous MPEG data stream carrying said on-screen display is received at said sink device via said serial interface; and
said isochronous MPEG data stream carrying said on-screen display is decoded at said sink device to provide said on-screen display.

23. A source device in accordance with claim 14, wherein:
said source device comprises a television terminal; and
said sink device comprises a high definition television.

24. A source device in accordance with claim 14, wherein:
said on-screen display comprises one of an electronic programming guide, a diagnostic menu, a video-on-demand menu, an advertisement, a pop-up graphic, an alert, a notice, a web page, a stock ticker, or a sports ticker.

25. A source device in accordance with claim 14, wherein:
said action comprises one of a user driven action or a software driven action.

26. A source device in accordance with claim 14, wherein:
said processor detects an action at the sink device deactivating the on-screen display;
said source device disables said passing of said isochronous MPEG data stream carrying said on-screen display to said sink device; and
said source device provides said active isochronous MPEG data stream to said sink device.
